(19) United States
(12) Patent Application Publication
(10) Pub. No.: US 2026/0014731 A1
(43) Pub. Date: Jan. 15, 2026

(54) APPLICATIONS OF A LINEAR SHAPED CHARGE ELECTRO-EXPLOSIVE (LSCe) DEVICE

(71) Applicant: Raytheon Company, Arlington, VA (US)

(72) Inventors: Eric D. Goertz, Whitewater, CO (US); Christopher F. Williams, Tucson, AZ (US); Montgomery Carlo, Sahuarita, AZ (US); Coulton T. Sadler, Tucson, AZ (US)

(21) Appl. No.: 19/218,002

(22) Filed: May 23, 2025

Related U.S. Application Data
(60) Provisional application No. 63/669,481, filed on Jul. 10, 2024.

(51) Int. Cl. B26F 3/04; F42B 3/10

(52) U.S. Cl. CPC B26F 3/04; F42B 3/10

(57) ABSTRACT

A linear shaped charged Electro-Explosive (LSCe) Device includes an initiator in direct and intimate contact with an exposed portion of the LSC's main charge. In different configurations, the initiator's package, initiation charge or initiation circuit (acting over a gap) are in direct and intimate contact with the main charge. The LSCe device may be manufactured by connecting a packaged initiator to an opening in the LSC housing through which a portion of the main charge is exposed or by forming the initiator in situ in a receptacle coupled to the housing around the opening. The LSCe device can be used for such applications as thrust or mechanical termination of an airframe, cable cutting or initiation of a LSC.

### CLAIM OF PRIORITY

This patent application claims the benefit of U.S. Provisional Patent Application No. 63/669,481, filed July 10, 2024, which is incorporated by reference herein in its entirety.

### BACKGROUND

### FIELD

This disclosure relates to Linear Shaped Charges (LSCs) and applications thereof.

### DESCRIPTION OF THE RELATED ART

Shape-forming charges are explosive charges shaped to focus the effect of the explosive's energy in specific direction and are purely kinetic in nature. A shape-forming charge is composed of two major components: an explosive charge and a metal liner on a forward surface of the explosive charge. Shape-forming charges may be used to penetrate armor, punch holes in naval vessels such as surface ships or submarines or to perforate wells in the oil and gas industry.

One type of shape-forming charge is referred to as a shaped charge. In a unitary shaped charge, the shaped charge liner has an "apex angle" of 40°-120° about an axis of the warhead (e.g., a conical shaped liner along the axis of the warhead). Upon detonation, the liner material collapses toward the centerline and is projected forward as both a slug and a metal jet. The slug makes up approximately 75% of the liner mass and has minimal penetration. The metal jet tip travels much faster than the slug (at least 2X) and thus has much greater penetration capabilities than the slug.

A central initiator, array of initiator or initiation waveguide shape the detonation wave(s) into a plane wave that strikes the metal liner to form the slug and metal jet. The enormous pressure at the front of the plane wave generated by the detonation of the explosive drives the liner in the hollow cavity inward to collapse upon its central axis to project a high-velocity jet of metal particles forward along the axis.

Linear Shaped Charges (LSCs) are an explosive product that produces a linear cutting jet to sever a wide range of materials and applications such as cutting launch vehicle and missile skins for stage separation, rocket motor thrust termination, aircraft egress, beaching, Explosive Ordinance Disposal (EOD), and other applications where fast and reliable cutting is required. A LSC is a continuous explosive core enclosed in a seamless metal sheath shaped in the form of an inverted V. Typical sheath (or liner) materials include copper, lead, tin alloy and aluminum. Commonly used explosive materials include RDX, PBXN-5, HNS, and HMX. Charge holders can be manufactured from a variety of materials such as structural foams, rigid plastics, or metal, depending on system integration, debris mitigation, and environmental systems. See Linear Shaped Charge (LSC) - Ensign-Bickford Aerospace & Defense, 2024.

An initiator is responsive to an electrical stimulus to detonate a small initiator charge (pellet), which in turn detonates the main charge to collapse the liner and form the linear cutting jet. A common initiator is called an Exploding Foil Initiator (EFI) (See US Patent No. 4, 788913), which converts electrical energy into mechanical energy in the form of an accelerating mass or "flyer plate" that impacts and detonates the small initiator charge. More specifically a high-voltage electrical stimulus creates a plasma from a foil, which drives another thin plastic or metal foil to create the mass or "flyer plate." The EFI includes the circuit, a gap such as provided by a barrel with a through hole or spacer through which the "flyer plate" is accelerated into the pellet.

Referring now to FIGS. 1A-1B, a typical LSC firing train 100, which is duplicated for initiation redundancy includes an Electronic Safe & Arm Device (ESAD) 102 that generates an electric stimulus 104 when one or more conditions are satisfied (e.g., platform disconnect, acceleration level satisfied, separation time met, etc.) The ESAD may, for example, generate a particular high-voltage waveform (e.g., 1200 V). An initiator 106 such as an EFI, Low Energy EFI (LEEFI), an exploding bridgewire (EBW) or low voltage detonator converts the electric stimulus 104 to an explosive output 108 (e.g., a primary detonation wave). The EFI and LEEFI convert the electric stimulus 104 to mechanical energy such as an accelerated mass or "flyer plate" that detonate an initiator charge (or "pellet") to produce the detonation wave, all within the EFI/LEEFI package. The explosive device output 108 is coupled to an end tip 110 of a detonation cord 112 as an explosive device input 114. Detonation cord 112 transfers the detonation wave 115 from Point A to Point B at another end tip 116 as an explosive device input 118, which detonates end tip 116 to produce another detonation wave that is coupled to a LSC 120, which in turn detonates the LSC's main or secondary charge 122 to produce a linear shaped charge jet 124.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure provides a linear shaped charged electro-explosive (LSCe) Device that includes an initiator in direct and intimate contact with an exposed portion of the LSC's main charge. In different configurations, the initiator's package, initiation charge or initiation circuit (acting over a gap) are in direct and intimate contact with the main charge. The LSCe device may be manufactured by connecting a packaged initiator to an opening in the LSC housing through which a portion of the main charge is exposed or by forming the initiator in situ in a receptacle coupled to the housing around the opening. The LSCe device can be used for such applications as thrust or mechanical termination of an airframe, cable cutting or initiation of a LSC.

In an embodiment, a LSC includes a main charge in a housing oriented along an axis. The main charge is compressed to form a V-shaped channel whose apex lies along the axis. A V-shaped metal liner is held in direct contact with the surface of the main charge. An opening in the housing exposes a portion of the main charge below the apex of the V-shaped channel. An initiator is positioned in direct and intimate contact with the exposed portion of the main charge through the opening, The initiator is responsive to an electric stimulus to detonate the main charge to form a detonation wave that collapses the V-shaped metal liner and projects forward a linear shaped charge jet.

In different embodiments, the initiator's package, initiator charge or initiation circuit (acting over a gap provided by a barrel having a through hole or a stand-off) are in direct and intimate contact with the main charge.

In different embodiments, the LSCe may be manufactured by connecting a packaged initiator to an opening in the LSC housing through which a portion of the main charge is exposed or by forming the initiator in situ in a receptacle coupled to the housing around the opening.

In different embodiments, the main charge may include one or more layers of explosive material having the same or different explosive compositions. The layers of the main charge and initiator charge may be pressed powder (e.g., a pyrotechnic fuel and oxidizer) or cast.

In different embodiments, the V-shaped channel and V-shaped metal liner have opposing surfaces joined at the apex with an apex angle of 40-120°. The V-shaped channel and V-shaped metal liner may be one of a V-shape in which the opposing surfaces are flat, a trumpet shape in which the opposing surfaces curve outward or a K-shape in which the opposing surfaces curve inward.

In different embodiments, the ends of the V-shaped channel may be open or closed, with closed ends providing better confinement of the of the detonation wave and improved tip velocity at the opposing ends.

In different embodiments, the housing includes a plurality of openings each exposing a different portion of the main charge below the apex of the V-shaped channels.

A plurality of initiators is positioned in direct and intimate contact with the different exposed portions of the main charge through the plurality of openings.

In different embodiments, the housing may be provided with mounting structures configurable to attach the LSCe device to a surface. The walls of the housing that confine the main charge are provided with sufficient mass to confine the detonation of the main charge and form the linear shaped charge jet and increase its tip velocity.

In different embodiments, the V-shaped channel can be formed without curvature in a straight line or with curvature in an arc or ring with the linear shaped charged jet projected either axially or radially.

These and other features and advantages of the disclosure will be apparent to those skilled in the art from the following detailed description of preferred embodiments, taken together with the accompanying drawings, in which:

### BRIEF DESCRIPTION OF THE DRAWINGS

FIGS. 1A-1B, as described above, illustrate a typical LSC firing train;

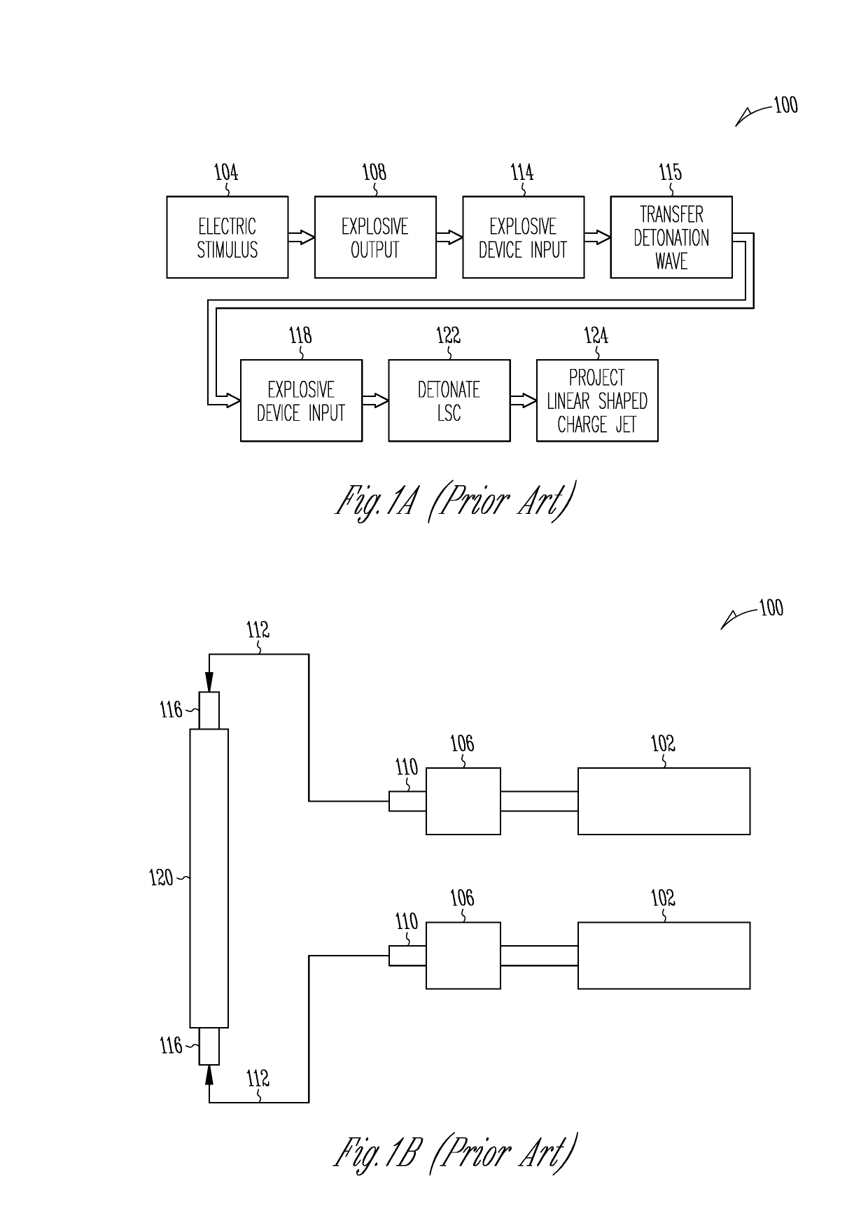

FIG. 2 is a simplified schematic of a LSCe device;

FIGS. 3A-3C are different embodiments of a LSCe device;

FIG. 4A is an exploded cross-sectional view of a packaged EFI attached to an opening in a linear shaped charge and 4B is a cross-sectional view in which a packaged EFI is integrated with the LSC with the packaged initiator in direct and intimate contact with the LSC's main charge in each configuration;

FIGS. 5A-5D illustrate an embodiment of a method of manufacturing the LSCe device of FIGS. 4B;

FIG. 6 is a cross-sectional view of an embodiment of an LSCe device in which an unpackaged initiator is integrated with the LSC with the initiator charge in direct and intimate contact with the LSC's main charge;

FIGS. 7A-7D illustrate an embodiment of a method of manufacturing the LSCe device of FIG. 6;

FIG. 8is a cross-sectional view of an embodiment of an LSCe device in which a initiator circuit is integrated with the LSC such that the initiator circuit operates across a gap in direct and intimate contact with the LSC's main charge;

FIGS. 9A-9D illustrate an embodiment of a method of manufacturing the LSCe device of FIG. 8;

FIGS. 10A-10B illustrate alternate trumpet and K-shaped liners for the LSC;

FIGS. 11A-11C are different views of an LSCe device integrated into a cutting tool; FIG. 12 is a perspective view of a flight termination system including one or more LSCe devices positioned on the missile skin near a propulsive engine to cut through the skin allowing for thrust termination;

FIGS. 13A-13C is a perspective view of a flight termination system including a circular ring LSCe device positioned on the missile skin forward of the rocket motor dome to cut through the dome for thrust termination;

FIG. 14 is a view of a LSCe device configured as a cutting tool to sever a cable;

FIG. 15 is a view of a high voltage power distribution network configured with a cutting tool to terminate power distribution; and

FIG. 16 is a view of a Linear Shaped Charge initiation system that uses an LSCe device to initiate a linear shape charge (LSC).

### DETAILED DESCRIPTION

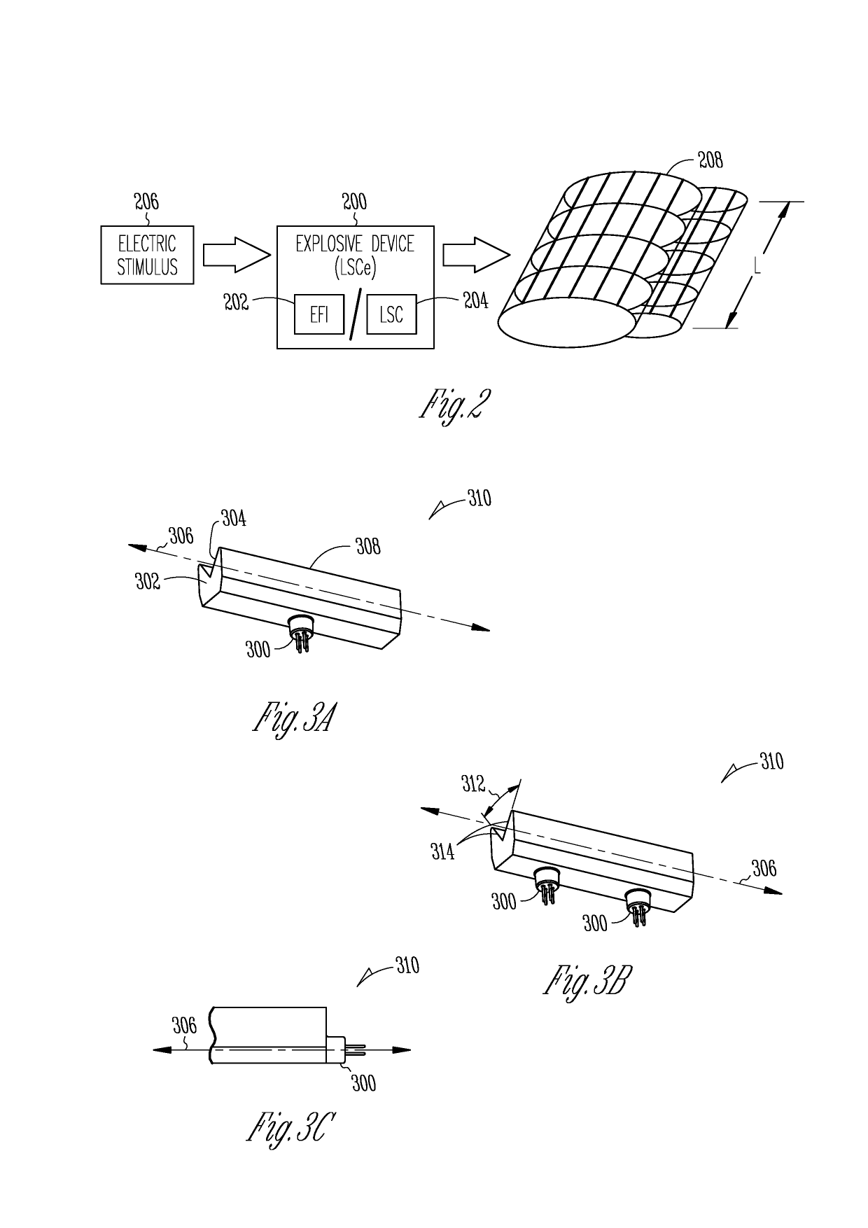

Referring now to FIG. 2, a LSCe device 200 includes an initiator 202 such as an EFI or LEEFI in direct and intimate contact with an exposed portion of a main charge of a LSC 204. LSCe device 200 is directly responsive to an applied electric stimulus 206 such as a high voltage waveform that may be provided by an ESAD or the like to detonate its main charge and produce a linear shaped charge jet 208. In different configurations, the initiator's package, initiation charge or initiation circuit (acting over a gap) are in direct and intimate contact with the main charge. The LSCe device may be manufactured by connecting a packaged initiator to an opening in the LSC housing through which a portion of the main charge is exposed or by forming the initiator in situ in a receptacle coupled to the housing around the opening.

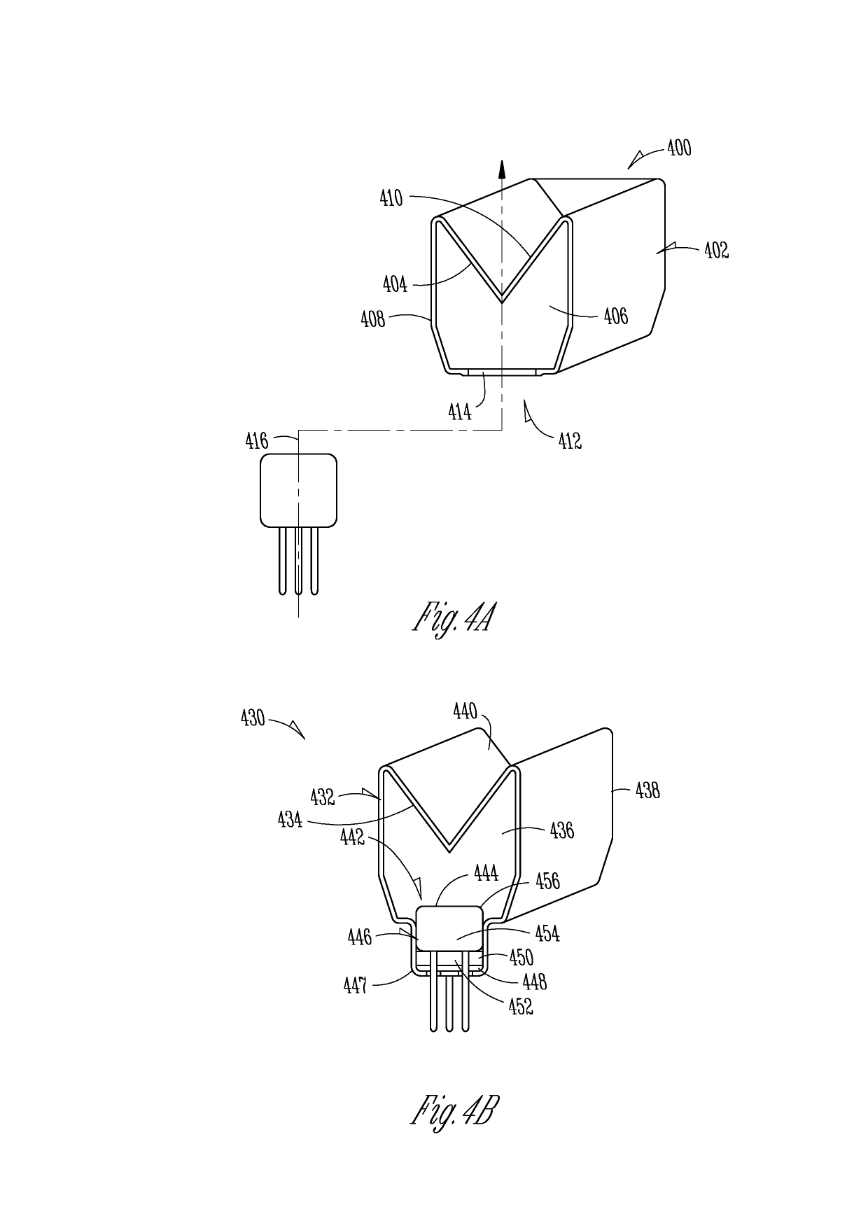

Referring now to FIGS. 3A-3C, one or more initiators 300 are positioned below the apex 302 of a V-shaped channel 304 formed in the main charge and intersecting a longitudinal axis 306 of the LSC 308 to ensure symmetric detonation of an LSCe device 310. The ends of the V-shaped channel may be open or closed, with closed ends providing better confinement of the of the detonation wave and a higher tip velocity of the linear shaped charge jet. In a typical LSCe device, the length L of the device along the axis is at least 10 times a width W of the device across the device. In absolute terms, the length L and hence the length of the linear shaped charge jet orthogonal to the direction of propagation of the jet is typically greater than 3 inches.

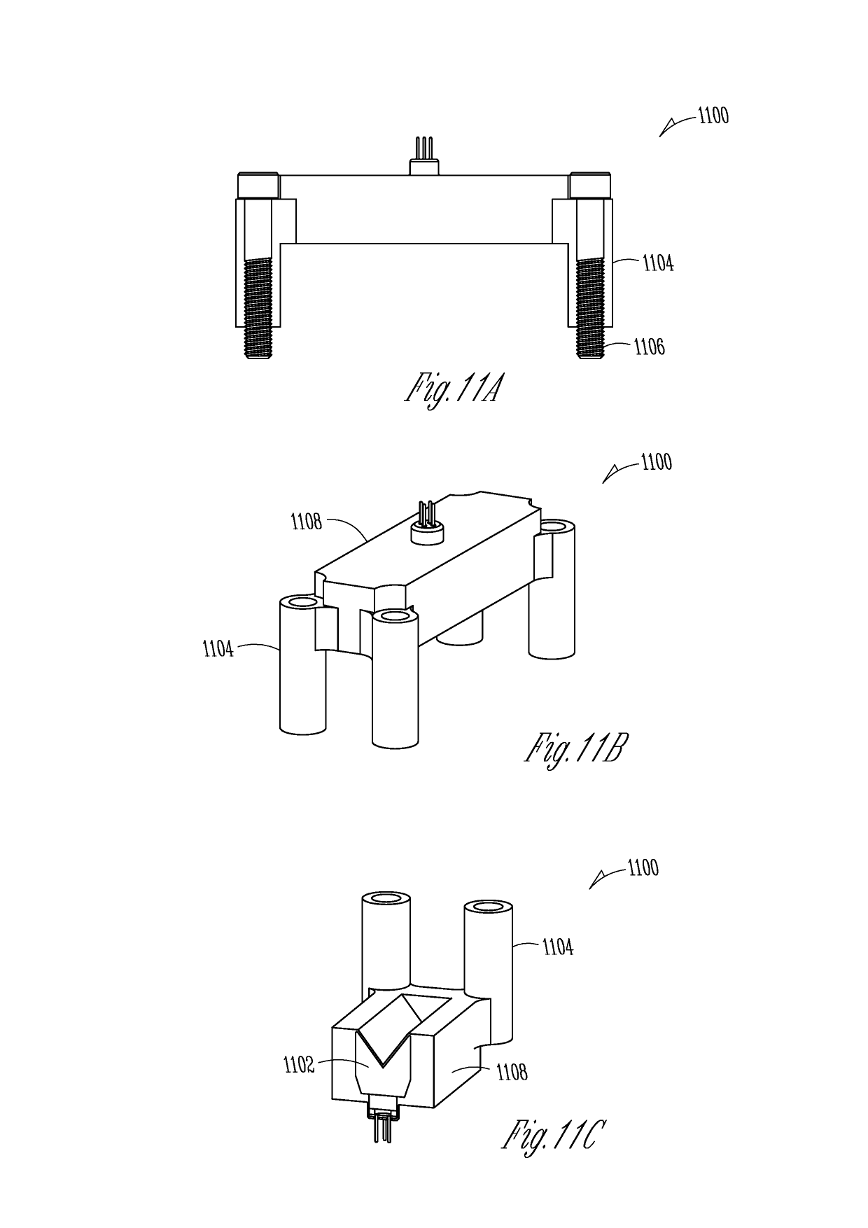

The V-shaped channel 304 (and V-shaped metal liner) have opposing surfaces joined at the apex 302 with an apex angle 312 of 40-120°. The V-shaped channel and V- shaped metal liner may be one of a V-shape in which the opposing surfaces 314 are flat as shown throughout the representative embodiment or, as shown in FIGS. 10A-10B have a trumpet shape 1000 in which the opposing surfaces 1002 extend forward from an apex 1003 and curve outward from an axis 1004 or a K-shape 1010 in which the opposing surfaces 1012 extend forward from an apex 1013 and curve inward towards an axis 1014.

In an embodiment, the initiator package is placed in direct and intimate contact with a portion of the LSC's main charge through an opening in the housing.

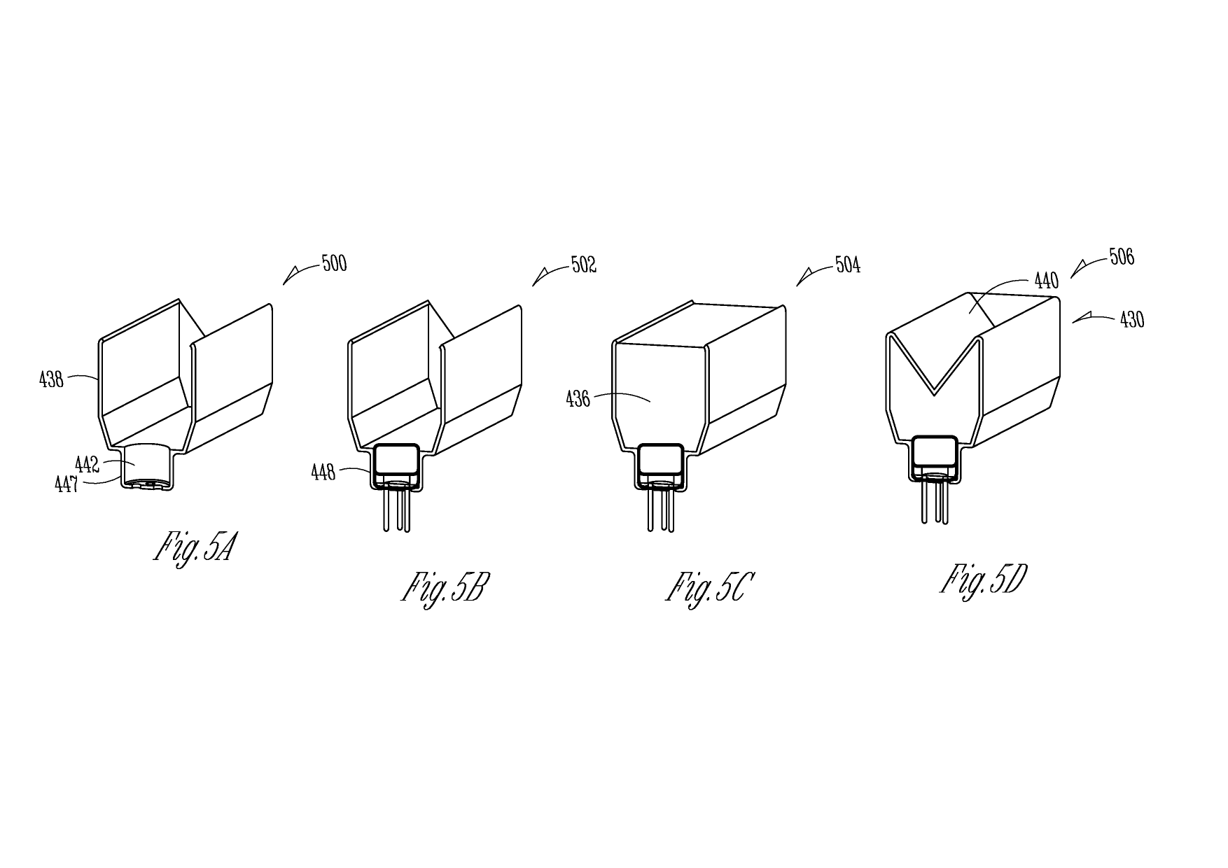

As shown in FIG. 4A, a LSCe device 400 includes a LSC 402 having a V-shaped channel 404 formed in a main charge 406 along an axis of a three-dimensional rectangularly-shaped housing 408. A metal liner 410 is positioned along the length of the V-shaped channel 404. An opening 412 in the bottom (or end) exposes a portion 414 of main charge 406. A packaged initiator 416 such as an EFI or LEEFI is connected (e.g., welded, threaded, fastened, etc.) to housing 408 around opening 412 such that a top surface of the packaged initiator 416 is in direct and intimate contact with the exposed portion 414 of main charge 406.

As shown in FIG. 4B, a LSCe device 430 includes a LSC 432 having a V-shaped channel 434 formed in a main charge 436 along an axis of a three-dimensional rectangularly-shaped housing 438. Main charge 436 may be one or more layers of the same or different explosive composition. A metal liner 440 is positioned along the length of the V-shaped channel 434. An opening 442 in the bottom (or end) exposes a portion 444 of main charge 436. A packaged initiator 446 such as an EFI or LEEFI is positioned in a receptacle 447 that is coupled to or integrally formed with housing 438 around opening 442 such that a top surface of the packaged initiator 446 is in direct and intimate contact with the exposed portion 444 of main charge 436. The packaged initiator 446 may be positioned in receptacle 447 from the top to sit in the receptacle or from the bottom and connected to the receptacle (e.g., welded).

As shown, packaged initiator 446 includes an initiation circuit 448, a barrel 450 with a through hole 452 that defines a gap and an initiator charge or "pellet" 454 in a package 456, typically metal. In the configurations of both FIGS. 4A and 4B, the packaged initiator is responsive to an electric stimulus such as provided by an ESAD. Initiation circuit 448 converts the electric stimulus to mechanical energy by accelerating a mass (e.g., formed by melting a plastic) across the gap formed by the through hole to impact and detonate initiator charge 454. The primary detonation wave is transferred through the thin top surface of package 456 and directly coupled to main charge 436 to initiate a secondary detonation wave that causes the V-shaped metal liner 440 to collapse and form the linear shaped charge jet.

Housings 408 and 438 may be made of thicker material to provide additional tamping and improved jet performance.

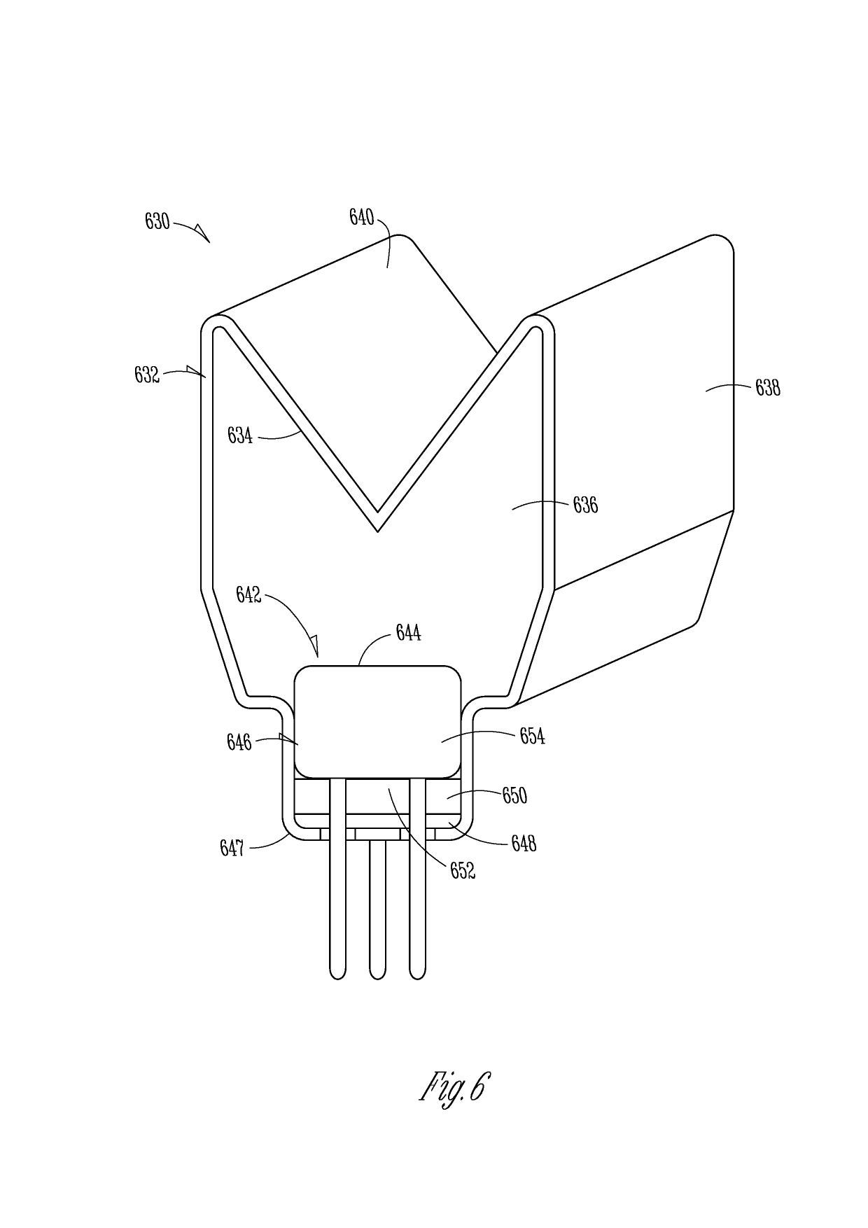

Referring now to FIGS. 5A-5D, an embodiment for manufacturing the LSCe device

Referring now to FIGS. 5A-5D, an embodiment for manufacturing the LSCe device 430 shown in FIG. 4B includes providing housing 438, suitably metal, in which the receptacle 447 is integrally formed with opening 442 coupling the receptacle 447 to the main housing (step 500). The packaged initiator 448 is positioned in receptacle 447 (step 502). The top surface of the packaged initiator 448 may extend through opening 442 into the main housing but it is not required. One or more layers of the same or different composition of explosive are formed to define the main charge 436 (step 504). The main charge may be formed via pressed powder or cast to define V-shaped channel 434. Metal liner 440 is positioned along the length of the V-shaped channel 434 (step 506).

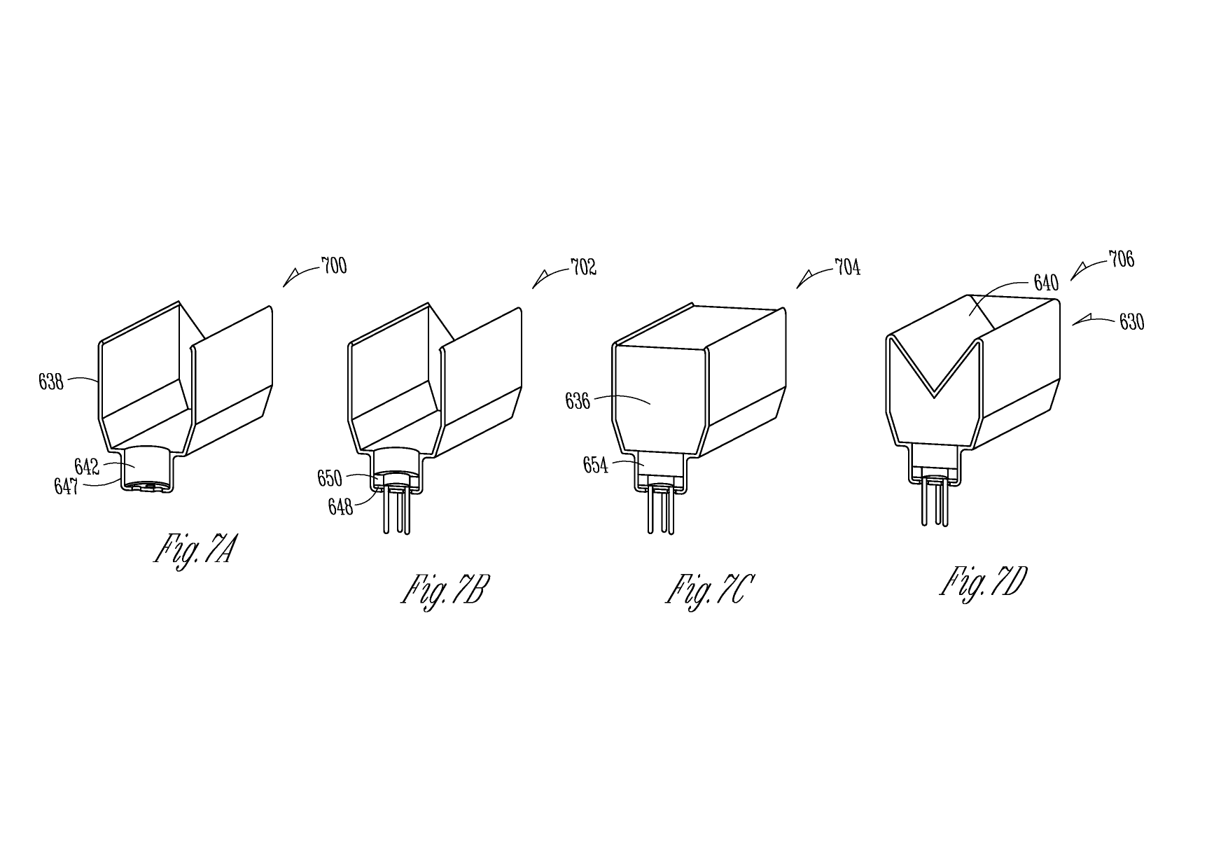

As shown in FIG. 6, a LSCe device 630 includes a LSC 632 having a V-shaped channel 634 formed in a main charge 636 along an axis of a three-dimensional rectangularly-shaped housing 638. Main charge 636 may be one or more layers of the same or different explosive composition. A metal liner 640 is positioned along the length of the V-shaped channel 634. An opening 642 in the bottom (or end) exposes a portion 644 of main charge 636.

Components for an initiator 646 such as an EFI or LEEFI include an initiation circuit 648, a barrel 650 with a through hole 652 that defines a gap and an initiator charge or "pellet" 654 are positioned in a receptacle 647 that is coupled to or integrally formed with housing 638 around opening 642 such that a top surface of the initiator charge 648 is in direct and intimate contact with the exposed portion 644 of main charge 636. Initiation circuit 648 converts the electric stimulus to mechanical energy by accelerating a mass (e.g., formed by melting a plastic) across the gap formed by the through hole to impact and detonate initiator charge 654. The primary detonation wave is directly coupled to main charge 636 to initiate a secondary detonation wave that causes the V-shaped metal liner 640 to collapse and form the linear shaped charge jet.

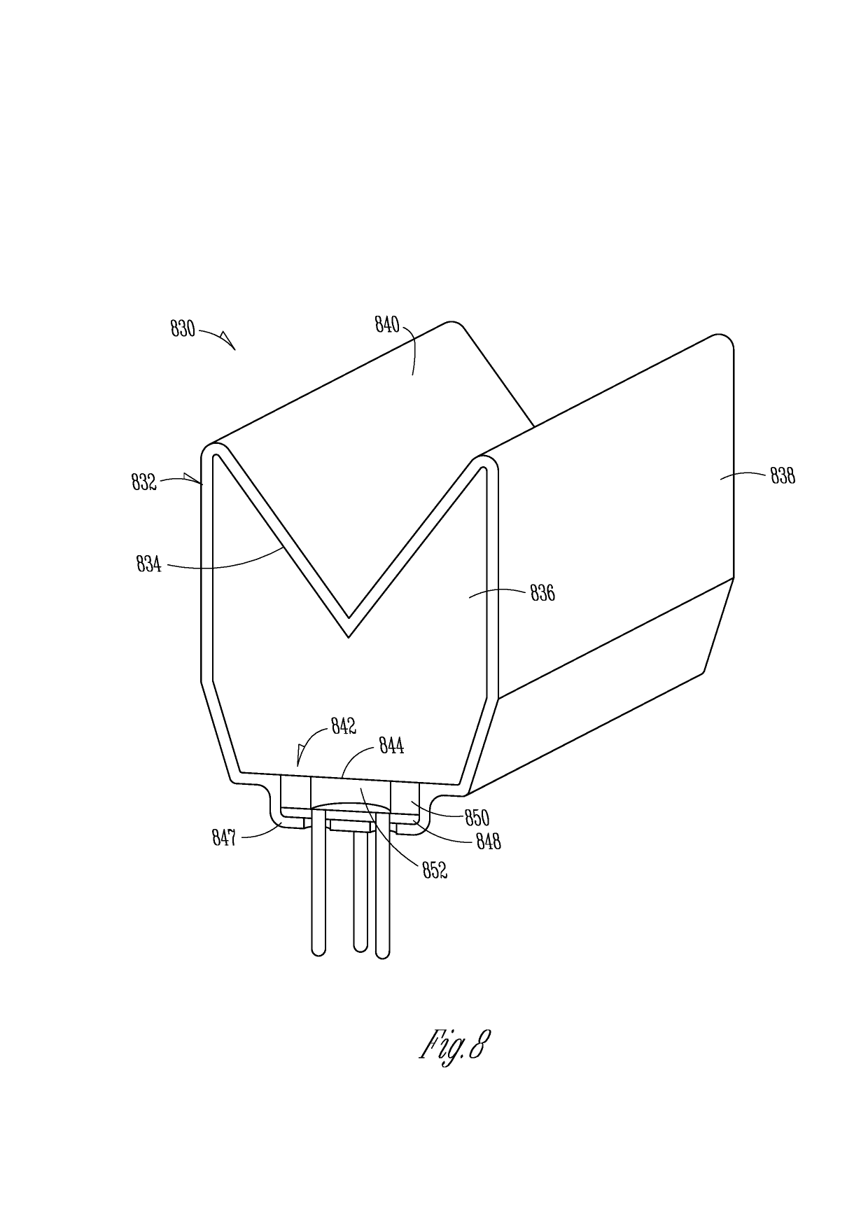

Referring now to FIGS. 7A-7D, an embodiment for manufacturing the LSCe device 630 shown in FIG. 6 includes providing housing 638, suitably metal, in which the receptacle 647 is integrally formed with opening 642 coupling the receptacle 647 to the main housing (step 700). The initiator components; initiator circuit 648, barrel 650 and initiator charge 654 are positioned in receptacle 647 (step 702). The top surface of the initiator charge 654 may extend through opening 642 into the main housing but it is not required. One or more layers of the same or different composition of explosive are formed to define the main charge 636 (step 704). The main charge may be formed via pressed powder or cast to define V-shaped channel 634. Metal liner 640 is positioned along the length of the V-shaped channel 634 (step 706).

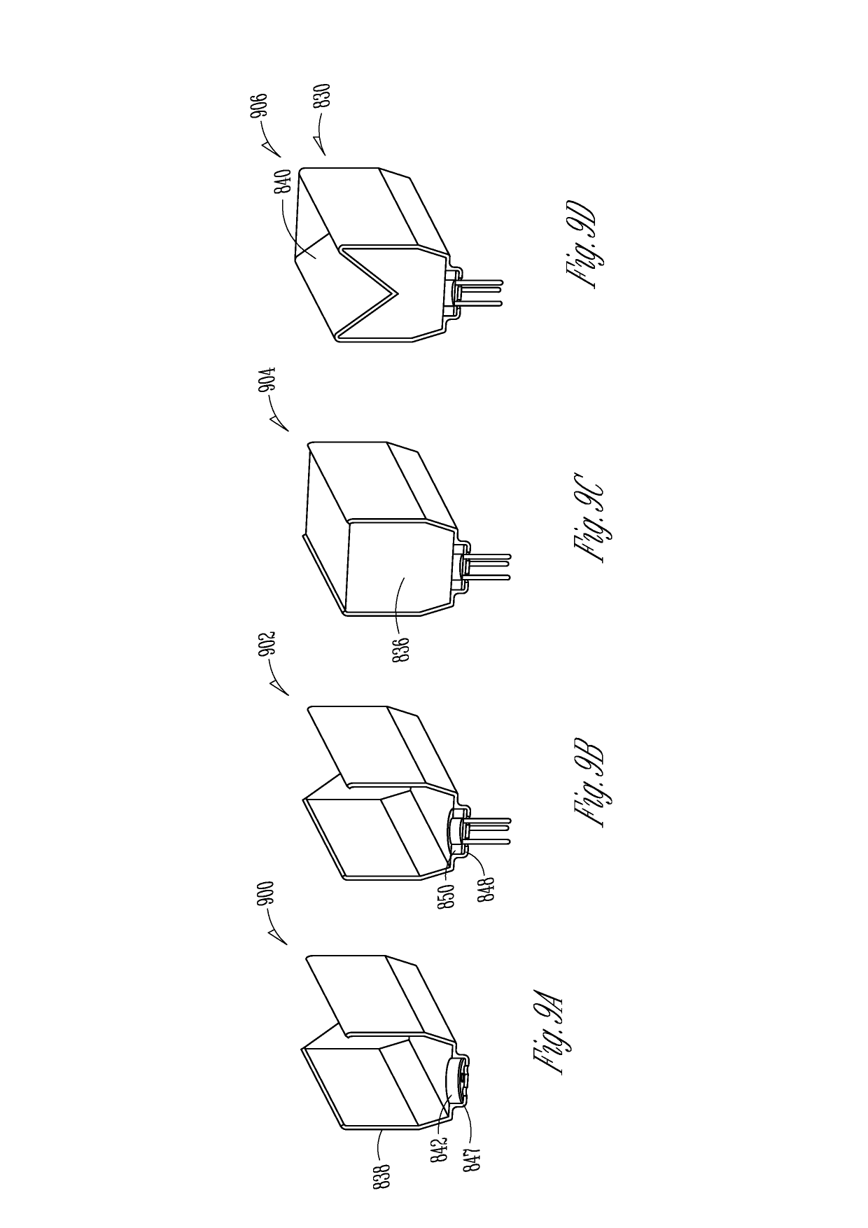

As shown in FIG. 8, a LSCe device 830 includes a LSC 832 having a V-shaped channel 834 formed in a main charge 836 along an axis of a three-dimensional rectangularly-shaped housing 838. Main charge 836 may be one or more layers of the same or different explosive composition. In an embodiment, main charge 836 is a single explosive composition. A metal liner 840 is positioned along the length of the V-shaped channel 834. An opening 842 in the bottom (or end) exposes a portion 844 of main charge 836.

An initiation circuit 848 and a barrel 850 with a through hole 852 that defines a gap for an initiator such as an EFI or LEEFI are positioned in a receptacle 847 that is coupled to or integrally formed with housing 838 around opening 842 such that the gap (a top surface of the barrel 850) is in direct and intimate contact with the exposed portion 844 of main charge 836. Initiation circuit 848 converts the electric stimulus to mechanical energy by accelerating a mass (e.g., formed by melting a plastic) across the gap formed by the through hole to impact and directly detonate main charge 836. The detonation wave that causes the V-shaped metal liner 840 to collapse and form the linear shaped charge jet.

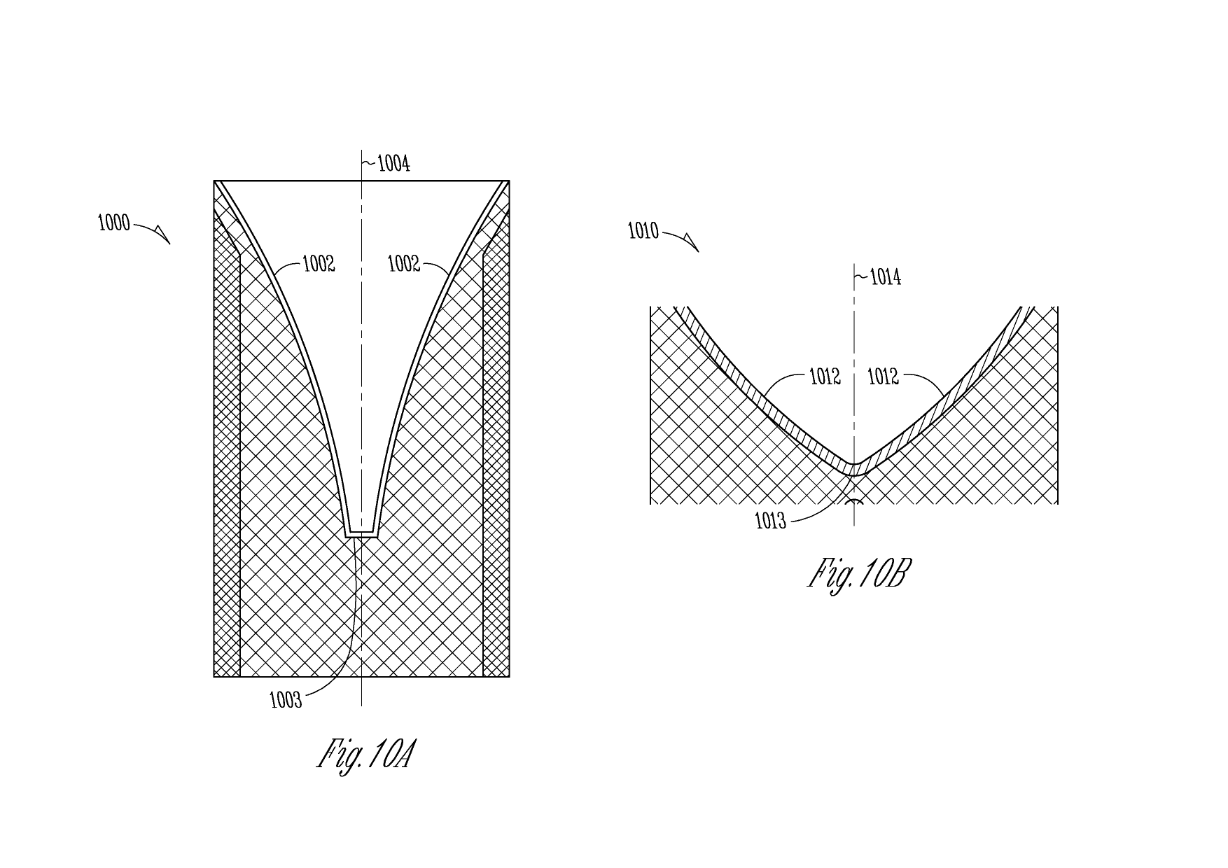

Referring now to FIGS. 9A-9D, an embodiment for manufacturing the LSCe device 830 shown in FIG. 8 includes providing housing 838, suitably metal, in which the receptacle 847 is integrally formed with opening 842 coupling the receptacle 847 to the main housing (step 900). The initiator circuit 848 and barrel 850 are positioned in receptacle 847 (step 902). The top surface of the barrel 850 may extend through opening 842 into the main housing but it is not required. One or more layers of the same or different composition of explosive are formed to define the main charge 836 (step 904). The main charge may be formed via pressed powder or cast to define V-shaped channel 834. To keep through hole 852 clear, a pin may be inserted from the bottom to cover the hole, form the main charge and then remove the pin or the hole may be covered with a membrane. Alternately, a very thin layer of material such as polyethylene could be formed over the hole to minimize any attenuation of the accelerated mass. Metal liner 840 is positioned along the length of the V-shaped channel 834 (step 906).

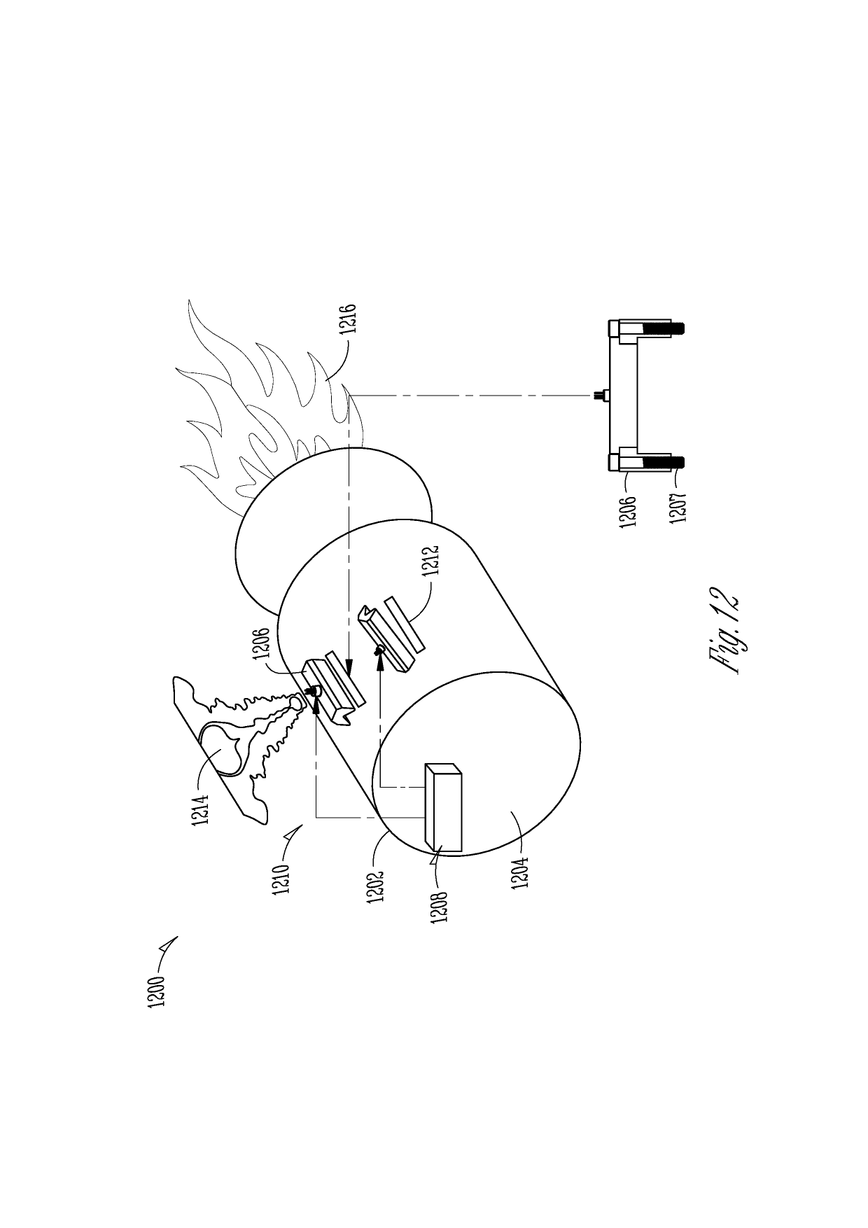

Referring now to FIGS. 11A-11C, a cutting tool 1100 includes a packaged LSCe device 1102. At a minimum, the packaging includes one or more stand-offs or legs 1104 for positioning the LSCe device 1102 with respect to an object to be cut at a stand-off to properly form the linear shaped charge jet. The one or more legs 1104 may include mechanisms 1106 such as threaded screws to secure the cutting tool 1100 to a surface and position the cutting tool to cut the object. If the V-shaped channel has a depth "X" measured to the apex of the V, the minimum stand-off should be at least X to properly form the linear shaped charge jet. This can be provided by legs as shown in the drawings or by configuring the package itself. The packaging may also include additional mass 1108 in the walls of the housing (or an additional housing around the LSC's housing) that serves to confine the detonation of the main charge and form the linear shaped charge jet and increase its tip velocity.

### Applications of an LSCe Device

Referring now to FIG. 12, an airframe 1200 such as a missile includes a rocket motor 1202 that includes a pressurized chamber. Venting of the pressurized chamber will cause rapid depressurization resulting in thrust termination of flight. A flight termination system (FTS) 1204 includes one or more linear shaped charge electro-explosive (LSCe) devices 1206 positioned on or near the surface of rocket motor 1202. Each LSCe device is held at a stand-off distance of at least X (the depth of the devices V-shaped channel) from the airframe either by the design of the device's housing or discrete stand-offs 1207. One or more safety devices 1208 are configured such that upon satisfaction of one or more conditions (e.g., a remote terminate command, one or more on-board health status sensors, etc.) the devices apply an electric stimulus via a firing harness 1210 to each LSCe device to project a linear shaped charge jet to cut the skin of rocket motor 1202 in a defined perforation area 1212 to vent 1214 the pressurized chamber to terminate thrust 1216. The LSCe devices 1204 may be positioned such that the linear shaped charge jet cuts the airframe in a manner that deteriorates the aerodynamics of the airframe to achieve mechanical termination.

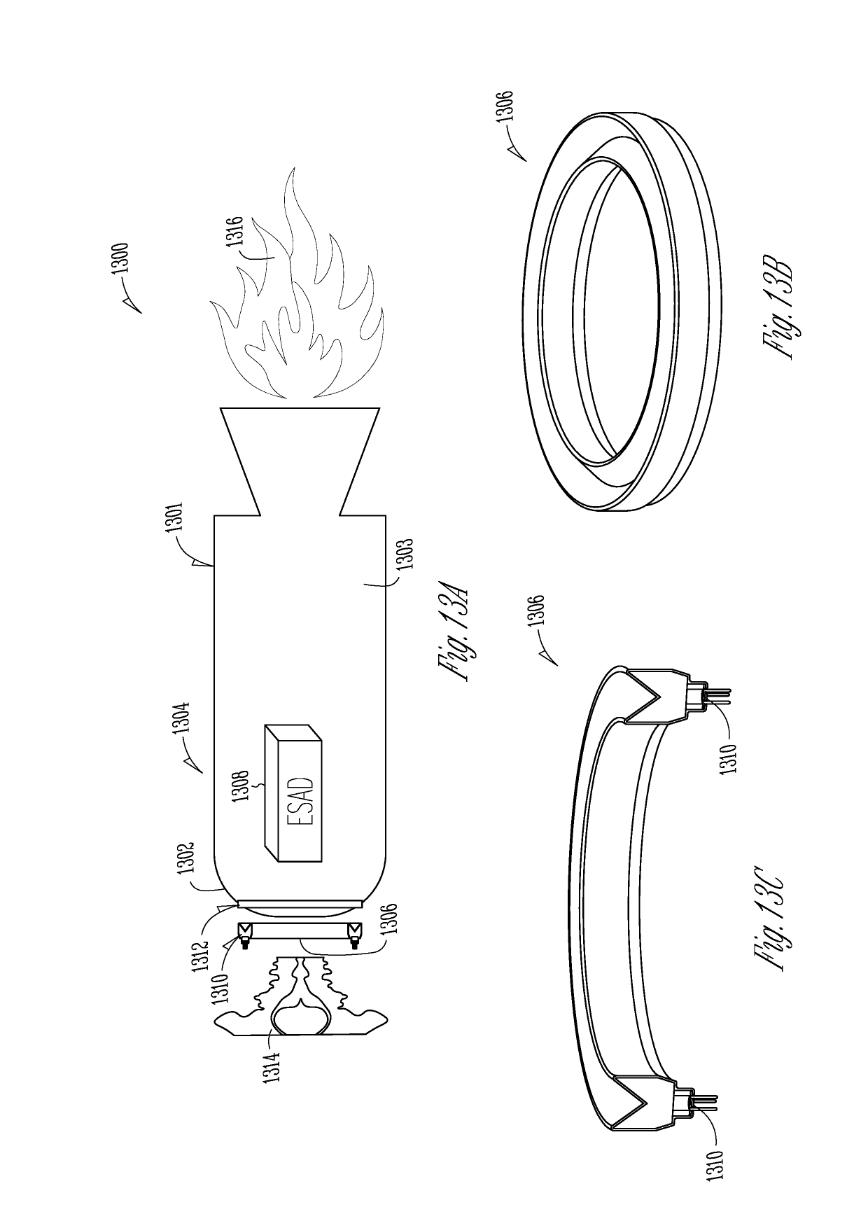

Referring now to FIG. 13, an airframe 1300 such as a missile includes a rocket motor 1301 having a rocket motor dome 1302 position forward of a pressurized chamber 1303. Venting of the pressurized chamber will cause rapid depressurization resulting in thrust termination of flight. A flight termination system (FTS) 1304 includes a linear shaped charge electro-explosive (LSCe) device 1306 formed as a circular ring in which the linear shaped charge jet is projected axially. The circular ring LSCe device 1306 is positioned forward of and at a requisite stand-off distance from rocket motor dome 1302. A safety device 1308 is configured such that upon satisfaction of one or more conditions (e.g., a remote terminate command, one or more on-board health status sensors, etc.) the safety device applies an electric stimulus at two initiation points 1310 to the circular ring LSCe device 1306 to project a circular ring linear shaped charge jet to cut the rocket motor dome 1302 to achieve a full 360 degree severance 1312 of the dome to vent 1314 the pressurized chamber to terminate thrust 1316. The circular ring LSCe device 1304 may also cut the airframe in a manner that deteriorates the aerodynamics of the airframe to achieve mechanical termination.

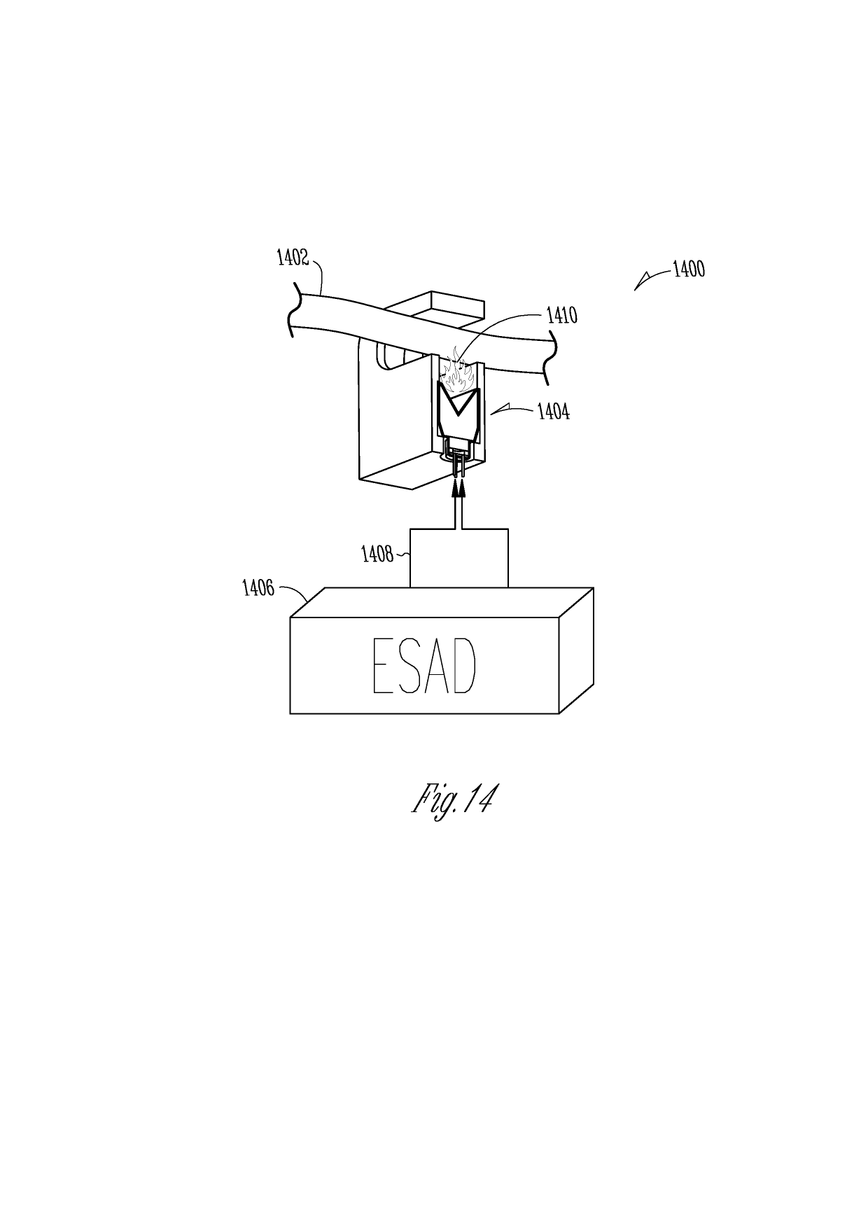

Referring now to FIG. 14, a cable cutting tool 1400 includes a fixture for receiving a cable 1402 and positioning an LSCe device 1404 at a stand-off distance from and oriented across cable 1402. The cable is one or more of a mechanical cable, electrical cable (high voltage, high current, data), optical cable or fluid cable (gas or liquid). Severing the cable may terminate or activate operation of a larger system or sub-system. A safety device 1406 is configured such that upon satisfaction of one or more conditions the device applies an electric stimulus via a firing harness 1408 to the LSCe device 1404 to projects forward a linear shaped charge jet 1410 to cut the cable 1402.

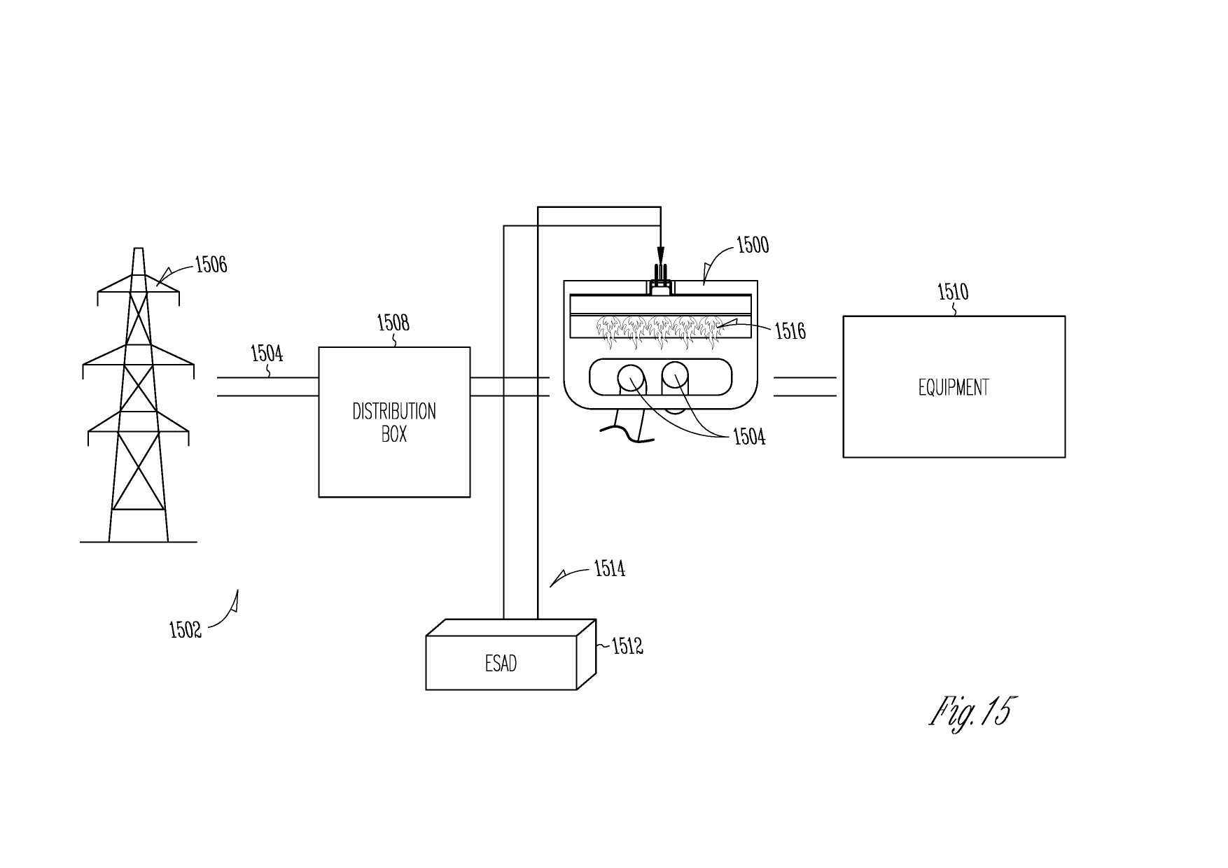

Referring now to FIG. 15, a cable cutting tool 1500 can implemented in a high- power distribution network 1502 to sever high power lines 1504 to remove power nearly instantaneously. Distribution network 1502 includes high voltage power transformers 1506 that that transmit power through high power lines 1504 to a distribution box 1508 where key power lines 1504 to equipment 1510 run through the cable cutting tool 1500. When the correct conditions are met, the ESAD 1512 sends a high voltage pulse through a firing harness 1514 which detonates the LSCe device 1500 to project a jet 1516 that cuts power lines 1504 removing power nearly instantaneously.

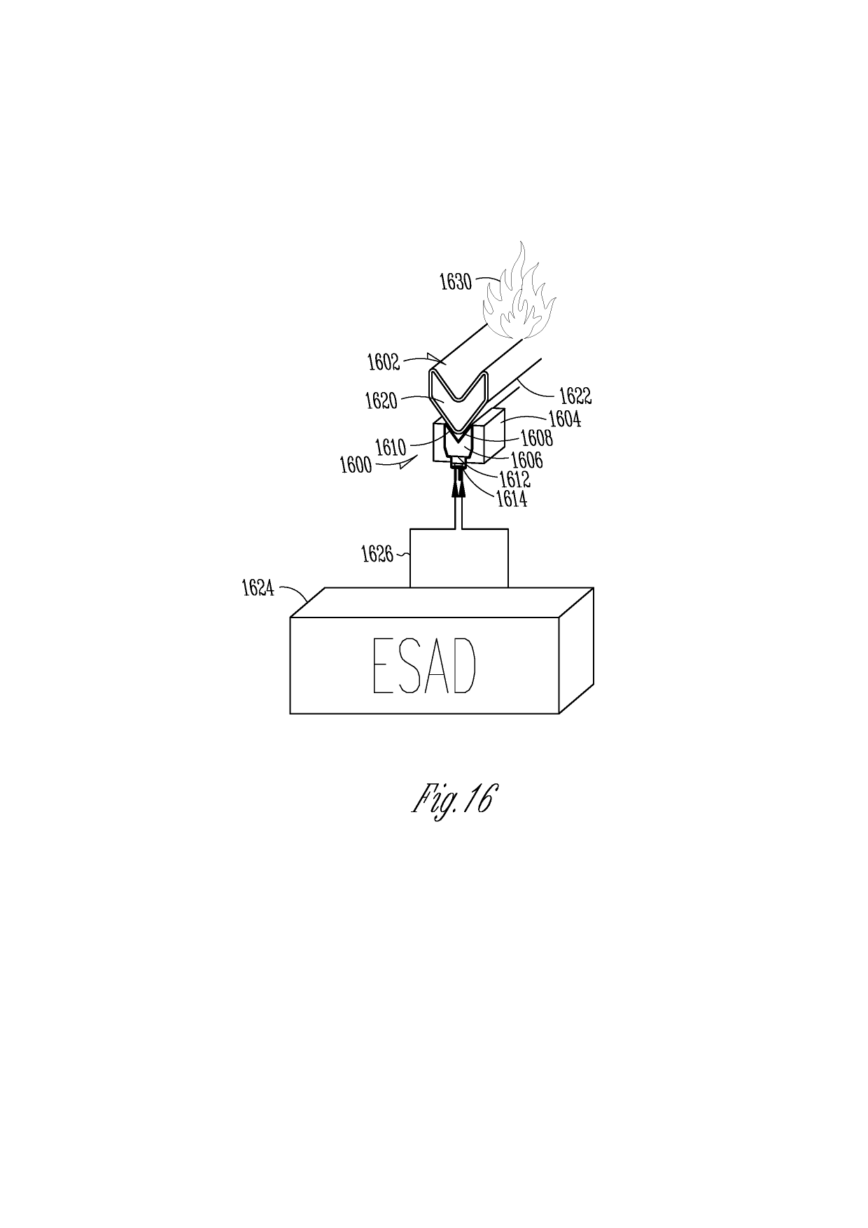

Referring now to FIG. 16, an LSCe device 1600 is configured to initiate a convention LSC 1602. Traditional initiation techniques that use “flyer plates” at one or more discrete locations have proven to be unreliable and inconsistent. Here the LSCe device 1600 initiates the conventional LSC along the length of the LSC 1602 thereby improving the reliability and consistency of initiation. A linear shaped charge system includes the LSCe device 1600 having a housing 1604 oriented along an axis, a main charge 1606 formed in the housing and compressed to form a V-shaped channel 1608 whose apex lies along the axis having a depth X and a V-shaped metal liner 1610 in direct contact with the surface of the main charge, an opening 1612 in the housing that exposes a portion of the main charge below the apex of the V-shaped channel, and an initiator 1614 in direct and intimate contact with the exposed portion of the main charge through the opening. LSC 1602 includes a V-shaped primary charge 1620 in a metal jacket 1622 positioned in the V-shaped channel opposite the V- shaped metal liner. A safety device 1624 is configured such that upon satisfaction of one or more conditions the device applies an electric stimulus via a firing harness 1626 to the initiator 1614 to detonate the main charge 1606 to form a detonation wave that collapses the V-shaped metal liner 1610 and projects forward a linear shaped charge jet through the metal jacket 1622 to initiate the V-shaped primary charge 1620 to form a linear cutting jet 1630. In an embodiment, the explosive power of the V-shaped primary charge 1620 is at least twice that of the main charge 1606. In different embodiments, the LSC’s metal jacket 1622 may either contact the LSCe device’s V-shaped metal liner 1610 or be held at a standoff distance of at least X from the LSCe device’s V-shaped metal liner 1610.

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

We claim:

1. A cutting tool, comprising:
a linear shaped charge electro-explosive (LSCe) device including a housing oriented along an axis, a main charge formed in the housing and compressed to form aV- shaped channel whose apex lies along the axis having a depth X and a V-shaped metal liner in direct contact with the surface of the main charge, an opening in the housing that exposes a portion of the main charge below the apex of the V-shaped channel, and an initiator in direct and intimate contact with the exposed portion of the main charge through the opening,
a fixture for positioning the LSCe device at stand-off distance of at least X from an object, and
a safety device configured upon satisfaction of one or more conditions to apply an electric stimulus to the initiator to detonate the main charge to form a detonation wave that collapses the V-shaped metal liner and projects forward a linear shaped charge jet to cut the object.

2. The cutting tool of claim 1, wherein the object is an airframe.

3. The cutting tool of claim 1, wherein the linear shaped charge jet cuts into the airframe to vent a pressurized chamber to achieve thrust termination.

4. The cutting tool of claim 1, wherein the linear shaped charge jet cuts into the airframe to deteriorate the aerodynamics of the airframe to achieve mechanical termination.

5. The cutting tool of claim 1, wherein the object is a cable.

6. The cutting tool of claim 5, wherein the fixture is configured to receive the cable approximately orthogonal to the LSCe device.

7. The cutting tool of claim 5, wherein the cable is one or more of a mechanical cable,
electrical cable (high voltage, high current, data), optical cable or fluid cable (gas or liquid).

8. A flight termination system (FTS), comprising:
an airframe;
a module in the airframe;
one or more linear shaped charge electro-explosive (LSCe) devices positioned on the module, each LSCe device including a housing oriented along an axis, a main charge formed in the housing and compressed to form a V-shaped channel whose apex lies along the axis having a depth X and a V-shaped metal liner in direct contact with the surface of the main charge, an opening in the housing that exposes a portion of the main charge below the apex of the V-shaped channel, and an initiator in direct and intimate contact with the exposed portion of the main charge through the opening,
a fixture for positioning the LSCe device at stand-off distance of at least X from the airframe, and
one or more safety devices configured upon satisfaction of one or more conditions to apply an electric stimulus to the initiator of each said LSCe device to detonate its main charge to form a detonation wave that collapses the V-shaped metal liner and projects forward a linear shaped charge jet to cut the module to terminate flight.

9. The FTS of claim 8, wherein the module is a rocket motor that includes a pressurized chamber, wherein the linear shaped charge jet ruptures the pressurize chamber to achieve thrust termination.

10. The FTS of claim 8, wherein the linear shaped charge jet cuts into the module to deteriorate the aerodynamics of the airframe to achieve mechanical termination.

11. The FTS of claim 8, wherein the fixture is either part of the housing or one or more discrete standoffs coupled to the housing.

12. A cable cutting tool, comprising:
a linear shaped charge electro-explosive (LSCe) device including a housing oriented along an axis, a main charge formed in the housing and compressed to form a V- shaped channel whose apex lies along the axis having a depth X and a V-shaped metal liner in direct contact with the surface of the main charge, an opening in the housing that exposes a portion of the main charge below the apex of the V-shaped channel, and an initiator in direct and intimate contact with the exposed portion of the main charge through the opening,
a fixture for receiving a cable and positioning the LSCe device at stand-off distance of at least X from and across the cable, and
a safety device configured upon satisfaction of one or more conditions to apply an electric stimulus to the initiator to detonate the main charge to form a detonation wave that collapses the V-shaped metal liner and projects forward a linear shaped charge jet to cut the cable.

13. The cutting tool of claim 12, wherein the cable is one or more of a mechanical cable, electrical cable (high voltage, high current, data), optical cable or fluid cable (gas or liquid).

14. A linear shaped charge system, comprising
a linear shaped charge electro-explosive (LSCe) device including a housing oriented along an axis, a main charge formed in the housing and compressed to form a V- shaped channel whose apex lies along the axis having a depth X and a V-shaped metal liner in direct contact with the surface of the main charge, an opening in the housing that exposes a portion of the main charge below the apex of the V-shaped channel, and an initiator in direct and intimate contact with the exposed portion of the main charge through the opening,
a linear shaped charge (LSC) including a V-shaped primary charge in a metal jacket positioned in the V-shaped channel opposite the V- shaped metal liner, and
a safety device configured upon satisfaction of one or more conditions to apply an electric stimulus to the initiator to detonate the main charge to form a detonation wave that collapses the V-shaped metal liner and projects forward a linear shaped charge jet through the metal jacket to initiate the V-shaped primary charge to form a linear cutting jet.

15. The linear shaped charge system of claim 14, wherein the linear shaped charge jet initiates the V-shaped primary charge along the entirety of its length.

16. The linear shaped charge system of claim 14, wherein the explosive power of the V-shaped primary charge is at least twice that of the main charge.

17. The linear shaped charge system of claim 14, wherein the LSC's metal jacket contact the LSCe device's V-shaped metal liner.

18. The linear shaped charge system of claim 14, wherein the LSC's metal jacket is held at a standoff distance of at least X from the LSCe device's V-shaped metal liner.
